(19) United States
(12) Patent Application Publication
(10) Pub. No.: US 2010/0175691 A1
(43) Pub. Date: Jul. 15, 2010

(54) PROCESS FOR RECYCLING CELLULOSE ACETATE ESTER WASTE

(75) Inventors: Michael T. Combs, Shady Spring, WV (US); Bruce Ray Woodson, Bluefield, VA (US)

Correspondence Address: HAMMER & ASSOCIATES, P.C., 3125 SPRINGBANK LANE, SUITE G, CHARLOTTE, NC, 28226, US

(73) Assignee: Celanese Acetate LLC

(21) Appl. No.: 12/686,619

(22) Filed: Jan. 13, 2010

Related U.S. Application Data
(60) Provisional application No. 61/144,775, filed on Jan. 15, 2009.

(51) Int. Cl. C13K 13/00

(52) U.S. Cl. 127/37

(57) ABSTRACT

A process for recycling cellulose acetate ester waste comprising the steps of: providing a reactor, adding cellulose acetate ester waste and a hydrolyzing agent to the reactor to create an agent/waste mixture followed by hydrolyzing the cellulose acetate ester waste by agitating and heating the agent/waste mixture for a period of time to create a hydrolyzed mixture. The hydrolyzing agent is then distilled and/or separated from the hydrolyzed mixture followed by separating and removing solid material from the hydrolyzed mixture to create a water soluble product stream which includes monosaccharides, polysaccharides, partially hydrolyzed cellulose, acetic acid, or combinations thereof. The water soluble product stream is then collected.

### RELATED CASES

This application claims the priority of the provisional application Ser. No. 61/144,775 filed Jan. 15, 2009.

### FIELD OF THE INVENTION

The invention relates to a method for recycling cellulose acetate ester waste resulting from the production of materials (e.g. tobacco products) through the use of carboxylic acids.

### BACKGROUND OF THE INVENTION

There is a long standing need to develop recycling methods which enable the processing of old materials into new products in order to both preserve limited natural resources and prevent the waste of potentially useful materials. When compared to virgin production, recycling also allows manufacturers to reduce energy usage, reduce air pollution, reduce water pollution, reduce the need for “conventional” waste disposal (i.e. a landfill), and lower greenhouse gas production. Some materials are easily recyclable such as glass, metal and paper. Other materials, such as plastic, textiles and electronics, are more difficult to recycle.

Cellulose acetate is the acetate ester of cellulose and is used for a variety of products which include, among other things, textiles (i.e. linings, blouses, dresses, wedding and party attire, home furnishings, draperies, upholstery and slip covers), industrial uses (i.e. cigarette and other filters for tobacco products, ink reservoirs for fiber tip pens), high absorbency products (i.e. diapers and surgical products), photography film, and computer tape. As with many processes, the manufacturing process results in some waste product which is not utilized in the final, desired product, as well as considerable waste post consumer. In the past, much of these waste products from the manufacture of products or post consumer used materials which incorporate cellulose acetate were simply shipped off to the landfill. Today, the desirability of so-called “green” manufacturing has increased remarkably. “Green” manufacturing includes the incorporation of recycled materials into the finished product, as well as the ability to reclaim previously used materials as either a fresh supply of the material being produced or the reuse of the original material in the production of a different material.

Hence, there exists an unsatisfied need for a process for the recycling of cellulose acetate ester waste resulting from the manufacture of other products.

### SUMMARY OF THE INVENTION

A process for recycling cellulose acetate ester waste comprising the steps of: providing a reactor, adding cellulose acetate ester waste and a hydrolyzing agent to the reactor to create an agent/waste mixture followed by hydrolyzing the cellulose acetate ester waste by agitating and heating the agent/waste mixture for a period of time to create a hydrolyzed mixture. The hydrolyzing agent is then distilled and/or separated from the hydrolyzed mixture followed by separating and removing solid material from the hydrolyzed mixture to create a water soluble product stream which includes monosaccharides, polysaccharides, partially hydrolyzed cellulose, acetic acid, or combinations thereof. The water soluble product stream is then collected.

### BRIEF DESCRIPTION OF THE DRAWINGS

For the purpose of illustrating the invention, there is shown in the figures a form that is presently preferred; it being understood, however, that this invention is not limited to the precise arrangements and instrumentalities shown.

FIG. 1 illustrates an embodiment of a process for recycling cellulose acetate waste.

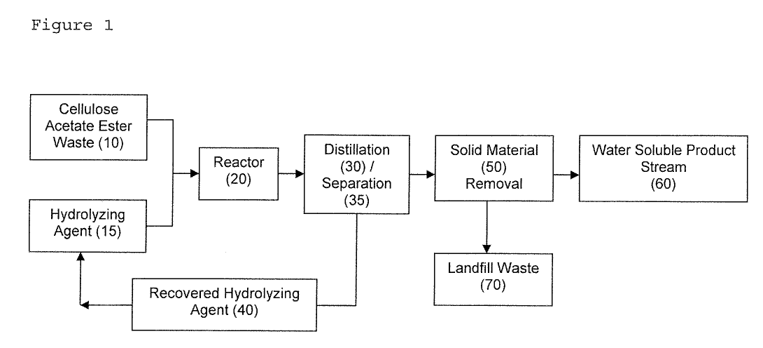

### DETAILED DESCRIPTION

The present invention relates to a process for the recycling of cellulose acetate ester waste 10 which results from the production of materials such as tobacco products. The present invention results in the reclamation of materials required for the production of cellulose acetate from existing cellulose acetate waste. The present invention also results in the reduction of solid waste which must be disposed of in a landfill or similar disposal site.

The instant invention describes a process for recycling cellulose acetate ester waste 10 by hydrolyzing an agent/waste mixture comprised of cellulose acetate ester and a hydrolyzing agent 15 within a reactor 20. The agent waste mixture is agitated and heated for a period of time within the reactor 20 to create a hydrolyzed mixture, from which both the hydrolyzing agent 15 and solid material 50 are distilled and/or separated out resulting in a water soluble product stream 60 comprising monosaccharides, polysaccharides, partially hydrolyzed cellulose, acetic acid, or combinations thereof. The water soluble product stream 60 is then collected for further use and/or processing.

Recycling, as used herein, refers to a process of waste management wherein used materials are converted into new products to (1) prevent the waste of potentially useful materials, (2) reduce the consumption of fresh materials, (3) reduce energy usage, (4) reduce air pollution, (5) reduce water pollution, (6) reduce the need for “conventional” waste disposal (i.e. a landfill), and (7) lowering greenhouse gas production when compared to virgin production. Recycle may refer to the creation of a fresh supply of the same material being recycled. Recycling may also refer to the reuse of the original material in the production of a different material (i.e. cardboard from used office paper).

Cellulose acetate ester waste 10, as used herein, refers to the cellulose acetate which is left over from any industrial process in which it may be utilized. Cellulose acetate ester waste 10 may also refer to the cellulose acetate incorporated into products resulting from any industrial process in which it may be utilized including post-consumer material. The cellulose acetate ester waste 10 may be a cellulose carboxylic ester which may include a cellulose acetate (DS 0.5-3), a cellulose diacetate, a cellulose triacetate, a cellulose acetate propionate (at various mixed ester composition), a cellulose acetate butyrate (at various mixed ester composition), other cellulose acetate esters or combinations thereof.

Reactor 20, as used herein, refers to a device which is a vessel designed to contain a chemical reaction. The reactor 20 may take the form of a tank (with or without mixing), a pipe, or a combination thereof. The reactor 20, regardless of its form, may be used as a continuous reactor or as a batch reactor. The reactor 20 may include any of the various types of reactors available which include, but are not limited to, continuous stirred-tank reactors, plug flow reactors, semi-batch reactors, fixed bed reactors or catalytic reactors.

Hydrolysis or hydrolyzing, as used herein, refers to a chemical reaction during which molecules of water are consumed in the process to break down one or more chemical bonds from one or more polymers or other chemical species. During the chemical process, a molecule is cleaved into two parts by the addition of a molecule of water. In the instant application, the acetate groups present on the cellulose acetate waste are displaced by a molecule of water such that a molecule of acetic acid is liberated from the polymer. In addition, the cellulose polymeric backbone can be hydrolyzed as well resulting in the formation of smaller chain saccharides, eventually leading to the liberation of glucose molecules.

Hydrolyzing agent 15, as used herein, refers to any suitable agent capable of hydrolyzing the cellulose acetate under normal hydrolysis conditions, i.e., those which do not otherwise adversely affect the cellulose. The hydrolyzing agent 15 may be an acid such as a carboxylic acid which may include acetic acid, formic acid, or a combination thereof. The hydrolyzing agent 15 may be supplied to the reactor 20 from either an outside source or from being generated or increased in-sito from hydrolyzation of the cellulose acetate waste as well as the consumption of water in the reaction as described within the instant invention. The initial concentration of hydrolyzing agent used may be in the range of 0% to 30%. In one embodiment of the instant invention, no hydrolyzing agent was used. In another embodiment a 10% concentration of hydrolyzing agent was used. In still another embodiment, a 20% concentration of hydrolyzing agent was used. In yet another embodiment, a 30% concentration of hydrolyzing agent was used.

The process for recycling cellulose acetate waste may further comprise additional steps which include recovering the hydrolyzing agent 40 by purification or isolation for subsequent use.

Agent/waste mixture, as used herein, refers to the mixture present within the reactor 20 after both the cellulose acetate ester waste 10 and the hydrolyzing agent 15 are added to the reactor 20. The agent/waste mixture is then agitated and heated within the reactor 20 for a period of time in order to hydrolyze the cellulose acetate ester waste 10 and create a hydrolyzed mixture.

Agitating, as used herein, refers to the act of putting something into motion through shaking or stirring. In the instant invention, materials are agitated throughout the recycling process, and especially while they reside within the reactor 20.

Heating, as used herein, refers to the act of causing another object to achieve a higher temperature. In the instant invention, materials are heated while they reside within the reactor 20 to a temperature preferably in the range of 140° C.-210° C., more preferably in the range of 150° C.-200° C., and most preferably in the range of 150° C.-185° C.

Period of time, as used herein, refers to refers to a duration which may range preferably from 0 minutes to 120 minutes and more preferably from 30 minutes to 90 minutes.

Hydrolyzed mixture, as used herein, refers to the mixture which results after the agent waste mixture is agitated and heated for a period of time within the reactor 20. The hydrolyzed mixture is comprised of, among other things, hydrolyzing agent 15, solid material 50 and water soluble product material. In one embodiment of the instant invention, the hydrolyzed mixture is primarily water soluble such that the solid material 50 of the cellulose acetate waste is reduced by greater than seventy-five percent (75%). In another embodiment, the solid material 50 of the cellulose acetate waste is reduced by greater than eighty-five percent (85%). In still another embodiment, the solid material 50 of the cellulose acetate waste is reduced by greater than ninety-five percent (95%). The hydrolyzed mixture then exits the reactor 20 in order to distill or separate out the remaining and newly created hydrolyzing agent 40.

Distilling 30, as used herein, refers to a method of separating a mixture based on the differences in their volatilities in a boiling liquid mixture. More specifically, distilling 30 refers to a process wherein a mixture of two or more compounds having different volatilities is heated to a temperature substantial enough to cause one compound to vaporize while the remaining compounds in the mixture remain substantially liquid. The vaporized compound is then separated from the mixture and collected. The vaporized compound may then be subjected to additional distillation 30 in order to achieve a more purified compound. The remaining mixture may also be subjected to additional distillation 30 in order to either achieve a more purified mixture and/or to separate an additional compound from the mixture. The distillation 30 may be carried out in any manner known in the art which may include, but is not limited to, batch distillation, continuous distillation, simple distillation, fractional distillation, steam distillation, vacuum distillation, molecular distillation, centrifugation or a combination thereof.

Separating out or separating 35, as used herein, refers to the process of separating one or more compounds from a mixture of two or more compounds and removing the compound(s) from the mixture. A compound may be separated 35 from and removed from a mixture my any known means including, but not limited to, distillation, filtration, absorption, adsorption, gravity separation, liquid-liquid extraction, osmosis, reverse-osmosis, purification, isolation or a combination thereof.

Solid material 50, as used herein, refers to a material contained within the hydrolyzed mixture resulting from the process described within the specification which is not soluble within the hydrolyzed mixture. More specifically, solid material 50 refers to material contained within the hydrolyzed mixture which is not water soluble. Solid material 50 may end up as landfill waste 70.

Water soluble product stream 60, as used herein, refers to a component of the above mentioned hydrolyzed mixture which comprises monosaccharides, polysaccharides, partially hydrolyzed cellulose, acetic acid, and/or combinations thereof.

Monosaccharides, as used herein, refer to the simplest form of carbohydrates which are generally water soluble. Monosaccharides include, but are not limited to, glucose, fructose, galactose, xylose, mannose and ribose. Monosaccharides are the building blocks of polysaccharides.

Polysaccharides, as used herein, refer to polymeric carbohydrate structures which are comprised of two or more monosaccharides. Polysaccharides may be water soluble, partially water soluble, or non-water soluble. Polysaccharides may include, but are not limited to starches, glycogens, cellulose, chitin.

Partially hydrolyzed cellulose, as used herein, refers to cellulose existing as a polysaccharide with a reduced molecular weight due to induced chain scission during hydrolysis, but not to the extent of hydrolysis to an oligosaccharide of less than glucose units.

Recovering the hydrolyzing agent, as used herein, refers to a process of removing the previously used and newly created hydrolyzing agent from the hydrolyzed mixture created within the reactor 20. The recovered hydrolyzing agent 40 may be recovered by any means known in the art which may include, but is not limited to, distillation, filtration, absorption, adsorption, gravity separation, liquid-liquid extraction, osmosis, reverse-osmosis, purification, centrifugation, isolation or a combination thereof.

Subsequent use, as used herein, refers to the reuse of recovered hydrolyzing agent 40 or the first time use of newly created recovered hydrolyzing agent 40 which was recovered from the hydrolyzed mixture within the reactor 20.

Degrading, as used herein, refers to the chemical decomposition of a chemical compound into elements or smaller compounds. More specifically in the process of the instant invention, the degradation of a cellulose polymer resulting from the hydrolysis of cellulose acetate ester waste 10 refers to the breaking down of the cellulose polymer into smaller compounds such as monosaccharides, polysaccharides, or combinations thereof. The process for recycling cellulose acetate waste may further comprise additional steps which include degrading a cellulose polymer resulting from the hydrolysis of the cellulose acetate ester waste 10. In one embodiment of the instant invention, the cellulose polymer resulting from the hydrolysis of cellulose acetate ester waste 10 proceeds to more than 30 percent of theoretical glucose yield.

Glucose conversion, as used herein, refers to the conversion of cellulose through any process known in the art into glucose.

Feedstock, as used herein refers to a material which may be used for subsequent processing.

Theoretical yield, as used herein, refers to the maximum amount of a specified product that could be obtained from specified amounts of reactants, assuming complete consumption of limiting reactant according to only one reaction and complete recovery of product. The theoretical yield may be compared to the actual yield which is the amount of a specified product actually obtained from a given reaction. In one embodiment of the instant invention, the hydrolysis of ester groups from the cellulose acetate ester waste 10 proceeds to more than seventy percent (70%) of theoretical yield.

In one embodiment of the instant invention, the monosaccharides and/or polysaccharides produced during the process of the instant invention may be isolated to use as feedstock for subsequent processing. In another embodiment of the instant invention, the monosaccharides and polysaccharides produced during the process of the instant invention may be further processed into products which include, but are not limited to, acetic acid, ethanol, or combinations thereof.

The invention also discloses a process for recycling cellulose acetate waste comprising the steps of: providing a reactor 20 and adding a cellulose acetate waste and a hydrolyzing agent 15 to the reactor 20 to create an agent/waste mixture followed by hydrolyzing the cellulose acetate ester waste 10 by agitating and heating the agent/waste mixture for a period of time to create a hydrolyzed mixture.

The process for recycling cellulose acetate waste may further comprise an additional step which includes distilling 30 and/or separating out 35 said hydrolyzing agent 15 from said hydrolyzed mixture.

The process for recycling cellulose acetate waste may further comprise an additional step which includes separating and removing solid material 50 from the hydrolyzed mixture to create a water soluble product stream comprised of monosaccharides, polysaccharides, partially hydrolyzed cellulose, or combinations thereof. The process may further comprise the step of collecting the water soluble product stream. The process may further comprise the step of recovering the hydrolyzing agent 40 by purification or isolation for subsequent use. The process may further comprise the step of degrading a cellulose polymer resulting from the hydrolysis of the cellulose acetate ester waste 10 proceeds to more than 30 percent of theoretical glucose yield.

The process may further comprise the step of processing the monosaccharides and/or polysaccharides to products such as acetic acid, ethanol, or combinations thereof.

In one embodiment of the instant invention the cellulose acetate ester waste 10 is hydrolyzed creating a hydrolyzed mixture to produce greater than 70% theoretical yield for acetic acid and greater than 30% theoretical yield for glucose in the reactor 20. The hydrolyzed mixture can then be separated from solid material 50 to reduce landfill waste 70, as well as, the water soluble product stream 60 can be used for subsequent processing including recovery of the acetic acid or further use of the glucose for other manufacturing processes.

### Examples

The following examples further illustrate the instant invention. Tables 1-4 detail the data obtained for the cellulose acetate hydrolysis achieved through the process described by the instant invention. Regarding Table 1, the blank is the concentration of aqueous acetic acid measured prior to its insertion into the reactor. This value was used to calculate the acetic acid yield. Also regarding Table 1, Cellulose Acetate Propionate—0.6 wt % acetyl; 42.5 wt % propionyl content and Cellulose Acetate Butyrate—2 wt % acetyl+52 wt % butyryl content. Each sample began with 40 grams of cellulose acetate ester waste which was combined with 600 ml of a hydrolyzing agent (acetic acid) within a Pressure Products Industries LC Series (Part No. LC-1X-F-SI-2X260-5-1B) 1 L magnetically stirred 316 Grade stainless steel reactor (Operation and Maintenance Manual for LC and FC Series Reactors Jan. 15, 1998 utilized) wherein the process was carried out for the durations shown below. The acid gain is detailed below (in grams) and the percent hydrolysis achieved for each sample. The percent acetic acid was determined by manual acid-base titration using a phenolphthalein visual endpoint. Titration was completed using standardized 1N sodium hydroxide. The titration endpoint was determined by the transition of clear solution to pink. The volume of NaOH titrant at the color transition point was used to calculate the % acetic acid in the representative sample. The sample was obtained from an aliquot of the reactor contents after allowing any solids to settle so that a relatively solids free sample could be obtained.

Tables 5-10 detail the data obtained for the glucose conversion achieved through the process described by the instant invention. Each sample began with 40 grams of cellulose acetate ester waste which was combined with 600 ml of a hydrolyzing agent (acetic acid and/or water) within a reactor wherein the process was carried out for the durations shown below. Regarding Tables 5-9, the column labeled “g glucose produced” illustrates the amount of glucose in solution. This amount was used to compare against theoretical yield to determine the % yield of glucose for each sample.

TABLE 1

| 600 ml aqueous | | | | | | | | |
|---|---|---|---|---|---|---|---|---|
| acetic acid (% | | | | | Time | Time | Time | Time |
| acid | | Sample | Temp | | (Minutes) | (Minutes) | (Minutes) | (Minutes) |
| concentration) | Sample ID | Type | (° C.) | Blank | 0 | 30 | 60 | 90 |
| 10% | 1A | CA Flake | 150 | | 8.70% | 9.60% | 10.70% | 10.70% |
| 10% | 1B | CA Flake | 150 | 9.90% | 8.20% | 9.70% | 10.40% | 10.30% |
| 20% | 2A | CA Flake | 150 | | 19.30% | 19.60% | 20.70% | 21.10% |
| 20% | 2B | CA Flake | 150 | 19.60% | 16.80% | 19.30% | 20.00% | 20.80% |
| 30% | 3A | CA Flake | 150 | | 26.40% | 29.20% | 30.30% | 31.40% |
| 30% | 3B | CA Flake | 150 | 29.30% | 25.60% | 29.30% | 30.00% | 31.30% |
| 10% | 4A | CA Flake | 175 | | 8.70% | 11.40% | 12.30% | 12.80% |
| 10% | 4B | CA Flake | 175 | 9.90% | 8.80% | 11.50% | 12.10% | 12.70% |
| 20% | 5A | CA Flake | 175 | | 16.80% | 21.30% | 22.00% | 22.20% |
| 20% | 5B | CA Flake | 175 | 20.20% | 16.80% | 21.30% | 21.20% | 22.10% |
| 30% | 6A | CA Flake | 175 | | 28.00% | 30.80% | 31.50% | 31.30% |
| 30% | 6B | CA Flake | 175 | 29.30% | 24.20% | 30.10% | 31.10% | 31.40% |
| 10% | 7A | CA Flake | 185 | 10.10% | 8.40% | 11.40% | 12.50% | 12.80% |
| 10% | 7B | CA Flake | 185 | 9.90% | 9.30% | 11.70% | 12.70% | 12.90% |
| 20% | 8A | CA Flake | 185 | 20.10% | 18.60% | 21.80% | 22.80% | 23.10% |
| 20% | 8B | CA Flake | 185 | 19.60% | 16.30% | 21.30% | 22.00% | 22.40% |
| 30% | 9A | CA Flake | 185 | 30.00% | 25.20% | 31.40% | 31.70% | 31.50% |
| 30% | 9B | CA Flake | 185 | 29.70% | 25.80% | 31.00% | 32.00% | 32.60% |
| 0.00% | 10A | CA Flake | 185 | 0.00% | 0.10% | 0.20% | 0.40% | 0.50% |
| 0.00% | 10B | CA Flake | 185 | 0% | 0.10% | 0.20% | 0.40% | 0.50% |
| 0.00% | 11A | CA Flake | 200 | 0.00% | 0.10% | 0.10% | 1.20% | 2.90% |
| 0.00% | 11B | CA Flake | 200 | 0.00% | 0.10% | 0.40% | 1.30% | 1.60% |
| 10% | 12 | Filter rod | 185 | 10% | 7.60% | 11.40% | 12.50% | |
| 10% | 13 | Cellulose | 185 | 10% | 7.80% | 10.30% | 10.80% | |
| | | Acetate- | | | | | | |
| | | Propionate | | | | | | |
| 10% | 14 | Cellulose | 185 | 10% | 9.70% | 9.90% | 10.30% | |
| | | Acetate- | | | | | | |
| | | Butyrate | | | | | | |

Table 1 illustrates the concentration of acetic acid obtained in the process of the instant invention at the various reaction times. % Concentration is calculated into yield in Tables 2-4.

TABLE 2

| | 30 min Calcs | | | |
|---|---|---|---|---|
| | Start Acid, | Acid Gain, | % | |
| Sample ID | gms | gm | Hydrolysis | |
| 1A | 60 | 1.44 | 6% | Sample 1 avg. |
| 1B | 60 | 2.08 | 9% | 7.9% |
| 2A | 120 | 5.44 | 24% | Sample 2 avg |
| 2B | 120 | 3.52 | 16% | 20.1% |
| 3A | 180 | 6.88 | 31% | Sample 3 avg |
| 3B | 180 | 7.52 | 34% | 32.3% |
| 4A | 60 | 12.96 | 58% | Sample 4 avg |
| 4B | 60 | 13.6 | 61% | 59.6% |
| 5A | 120 | 16.32 | 73% | Sample 5 avg |
| 5B | 120 | 16.32 | 73% | 73.2% |
| 6A | 180 | 17.12 | 77% | Sample 6 avg |
| 6B | 180 | 12.64 | 57% | 66.8% |
| 7A | 60 | 12.96 | 58% | Sample 7 avg |
| 7B | 60 | 14.88 | 67% | 62.5% |
| 8A | 120 | 19.52 | 88% | Sample 8 avg |
| 8B | 120 | 16.32 | 73% | 80.4% |
| 9A | 180 | 20.96 | 94% | Sample 9 avg |
| 9B | 180 | 18.4 | 83% | 88.3% |
| 10A | 0 | 1.28 | 6% | Sample 10 avg |
| 10B | 0 | 1.28 | 6% | 5.7% |
| 11A | 0 | 0.64 | 3% | Sample 11 avg |
| 11B | 0 | 2.56 | 11% | 7.2% |
| 12A | 60 | 12.96 | 58% | |
| 13 | 60 | 7.28* | 32% | |
| 14 | 60 | 4.86* | 18% | |

*adjusted for mixed acid content

Table 2 illustrates the effects of various temperatures and concentrations of hydrolyzing agent on the process to produce acetic acid of the instant invention at the thirty minute mark.

TABLE 3

| | 60 min Calcs | | | |
|---|---|---|---|---|
| | Start Acid, | Acid Gain, | % | |
| Sample ID | gms | gm | Hydrolysis | |
| 1A | 60 | 8.48 | 38% | Sample 1 avg. |
| 1B | 60 | 6.56 | 29% | 33.8% |
| 2A | 120 | 12.48 | 56% | Sample 2 avg |
| 2B | 120 | 8 | 36% | 46.0% |
| 3A | 180 | 13.92 | 62% | Sample 3 avg |
| 3B | 180 | 12 | 54% | 58.2% |
| 4A | 60 | 18.72 | 84% | Sample 4 avg |
| 4B | 60 | 17.44 | 78% | 81.1% |
| 5A | 120 | 20.8 | 93% | Sample 5 avg |
| 5B | 120 | 15.68 | 70% | 81.9% |
| 6A | 180 | 21.6 | 97% | Sample 6 avg |
| 6B | 180 | 19.04 | 85% | 91.2% |
| 7A | 60 | 20 | 90% | Sample 7 avg |
| 7B | 60 | 21.28 | 96% | 92.6% |
| 8A | 120 | 25.92 | 116% | Sample 8 avg |
| 8B | 120 | 20.8 | 93% | 104.8% |
| 9A | 180 | 22.88 | 103% | Sample 9 avg |
| 9B | 180 | 24.8 | 111% | 107.0% |
| 10A | 0 | 2.56 | 11% | Sample 10 avg |
| 10B | 0 | 2.56 | 11% | 11.5% |
| 11A | 0 | 7.68 | 34% | Sample 11 avg |
| 11B | 0 | 8.32 | 37% | 35.9% |
| 12A | 60 | 20 | 90% | |
| 13 | 60 | 11.22* | 50% | |
| 14 | 60 | 8.57* | 32% | |

*adjusted for mixed acid content

Table 3 illustrates the effects of various temperatures and concentrations of hydrolyzing agent to produce acetic acid on the process of the instant invention at the sixty minute mark.

TABLE 4

| | 90 min Calcs | | | |
|---|---|---|---|---|
| | Start Acid, | Acid Gain, | % | |
| Sample ID | gms | gm | Hydrolysis | |
| 1A | 60 | 8.48 | 38% | Sample 1 avg. |
| 1B | 59.4 | 6.52 | 29% | 33.7% |
| 2A | 120 | 15.04 | 68% | Sample 2 avg |
| 2B | 117.6 | 15.52 | 70% | 68.6% |
| 3A | 180 | 20.96 | 94% | Sample 3 avg |
| 3B | 175.8 | 24.52 | 110% | 102.1% |
| 4A | 60 | 21.92 | 98% | Sample 4 avg |
| 4B | 59.4 | 21.88 | 98% | 98.3% |
| 5A | 120 | 22.08 | 99% | Sample 5 avg |
| 5B | 121.2 | 20.24 | 91% | 95.0% |
| 6A | 180 | 20.32 | 91% | Sample 6 avg |
| 6B | 175.8 | 25.16 | 113% | 102.1% |
| 7A | 60 | 21.92 | 98% | Sample 7 avg |
| 7B | 59.4 | 23.16 | 104% | 101.2% |
| 8A | 120 | 27.84 | 125% | Sample 8 avg |
| 8B | 117.6 | 25.76 | 116% | 120.3% |
| 9A | 180 | 21.6 | 97% | Sample 9 avg |
| 9B | 178.2 | 30.44 | 137% | 116.8% |
| 10A | 0 | 3.2 | 14% | Sample 10 avg |
| 10B | 0 | 3.2 | 14% | 14.4% |
| 11A | 0 | 18.56 | 83% | Sample 11 avg |
| 11B | 0 | 10.24 | 46% | 64.6% |

Table 4 illustrates the effects of various temperatures and concentrations of hydrolyzing agent to produce acetic acid on the process of the instant invention at the ninety minute mark.

TABLE 5

| | | | Time | g Glucose | |
|---|---|---|---|---|---|
| Sample Name | Temp (° C.) | % Acid | (min.) | Produced | % yield |
| 9A | 185 | 30 | 90 | 6.961937 | 28.7 |
| 1A | 150 | 10 | 0 | 0.163579 | 0.7 |
| 1A | 150 | 10 | 30 | 0.173621 | 0.7 |
| 1A | 150 | 10 | 60 | 0.281637 | 1.2 |
| 1A | 150 | 10 | 90 | 0.277401 | 1.1 |
| 2A | 150 | 20 | 0 | 0.163579 | 0.7 |
| 2A | 150 | 20 | 30 | 0.963122 | 4.0 |
| 2A | 150 | 20 | 60 | 2.517387 | 10.4 |
| 2A | 150 | 20 | 90 | 3.396408 | 14.0 |
| 3A | 150 | 30 | 0 | 0.163579 | 0.7 |
| 3A | 150 | 30 | 30 | 2.733152 | 11.3 |
| 3A | 150 | 30 | 60 | 2.86062 | 11.8 |
| 3A | 150 | 30 | 90 | 4.70759 | 19.4 |
| 4A | 175 | 10 | 0 | 0.163579 | 0.7 |
| 4A | 175 | 10 | 30 | 2.655546 | 10.9 |
| 4A | 175 | 10 | 60 | 3.992691 | 16.5 |
| 4A | 175 | 10 | 90 | 4.469286 | 18.4 |
| 5A | 175 | 20 | 0 | 0.163579 | 0.7 |
| 5A | 175 | 20 | 30 | 7.633899 | 31.5 |
| 5A | 175 | 20 | 60 | 9.6868 | 39.9 |
| 5A | 175 | 20 | 90 | 9.824415 | 40.5 |

Table 5 illustrates the percent yield of glucose for samples 1A-5A after 0, 30, 60 and 90 minutes at the specified temperature.

TABLE 6

| Sample | | | Time | g Glucose | |
|---|---|---|---|---|---|
| Name | Temp (° C.) | % Acid | (min.) | Produced | % yield |
| 6A | 175 | 30 | 0 | 0.278731 | 1.1 |
| 6A | 175 | 30 | 30 | 7.299968 | 30.1 |
| 6A | 175 | 30 | 60 | 8.947011 | 36.9 |
| 6A | 175 | 30 | 90 | 7.554323 | 31.1 |
| 7A | 185 | 10 | 0 | 0.163579 | 0.7 |
| 7A | 185 | 10 | 30 | 4.953735 | 20.4 |
| 7A | 185 | 10 | 60 | 8.444482 | 34.8 |
| 7A | 185 | 10 | 90 | 7.182493 | 29.6 |
| 8A | 185 | 20 | 0 | 0.163579 | 0.7 |
| 8A | 185 | 20 | 30 | 7.302601 | 30.1 |
| 8A | 185 | 20 | 60 | 6.000584 | 24.7 |
| 8A | 185 | 20 | 90 | 4.699918 | 19.4 |
| 9A | 185 | 30 | 0 | 0.163579 | 0.7 |
| 9A | 185 | 30 | 30 | 7.075416 | 29.2 |
| 9A | 185 | 30 | 60 | 5.707677 | 23.5 |
| 9A | 185 | 30 | 90 | 4.268733 | 17.6 |
| 10A | 185 | 0 | 0 | 0.19954 | 0.8 |
| 10A | 185 | 0 | 30 | 0.171365 | 0.7 |
| 10A | 185 | 0 | 60 | 0.180927 | 0.7 |
| 11A | 200 | 0 | 0 | 0.1635788 | 0.7 |
| 11A | 200 | 0 | 30 | 1.6475698 | 6.8 |
| 11A | 200 | 0 | 60 | 2.05165353 | 8.5 |
| 11A | 200 | 0 | 90 | 5.00462951 | 20.6 |
| 10A | 185 | 0 | 90 | 0.164557 | 0.7 |

Table 6 illustrates the percent yield of glucose for samples 6A-11A after 0, 30, 60 and 90 minutes at the specified temperature.

TABLE 7

| | Temp | | Time | g Glucose | % Glucose |
|---|---|---|---|---|---|
| Sample Name | (° C.) | % Acid | (min.) | Produced | Yield |
| 1B | 150 | 10 | 0 | 0.24597332 | 1.0 |
| 1B | 150 | 10 | 30 | 0.21647196 | 0.9 |
| 1B | 150 | 10 | 60 | 0.34181325 | 1.4 |
| 1B | 150 | 10 | 90 | 0.41465069 | 1.7 |
| 2B | 150 | 20 | 0 | 0.1635788 | 0.7 |
| 2B | 150 | 20 | 30 | 1.78085377 | 7.3 |
| 2B | 150 | 20 | 60 | 3.06420319 | 12.6 |
| 2B | 150 | 20 | 90 | 4.64805526 | 19.2 |
| 3B | 150 | 30 | 0 | 0.1635788 | 0.7 |
| 3B | 150 | 30 | 30 | 0.92122665 | 3.8 |
| 3B | 150 | 30 | 60 | | |
| 3B | 150 | 30 | 90 | 2.72399519 | 11.2 |
| 4B | 175 | 10 | 0 | 0.1635788 | 0.7 |
| 4B | 175 | 10 | 30 | 3.47439421 | 14.3 |
| 4B | 175 | 10 | 60 | 8.02597294 | 33.1 |
| 4B | 175 | 10 | 90 | 7.87832872 | 32.5 |
| 5B | 175 | 20 | 0 | 0.28534664 | 1.2 |
| 5B | 175 | 20 | 30 | 9.29981108 | 38.3 |
| 5B | 175 | 20 | 60 | 12.6850028 | 52.3 |
| 5B | 175 | 20 | 90 | 10.3929737 | 42.9 |
| 6B | 175 | 30 | 0 | 0.25816728 | 1.1 |
| 6B | 175 | 30 | 30 | 1.27912219 | 5.3 |
| 6B | 175 | 30 | 60 | 5.47351869 | 22.6 |
| 6B | 175 | 30 | 90 | 9.08919337 | 37.5 |

Table 7 illustrates the percent yield of glucose for samples 1B-6B after 0, 30, 60 and 90 minutes at the specified temperature.

TABLE 8

| | Temp | | Time | g Glucose | % Glucose |
|---|---|---|---|---|---|
| Sample Name | (° C.) | % Acid | (min.) | Produced | Yield |
| 7B | 185 | 10 | 0 | 0.1635788 | 0.7 |
| 7B | 185 | 10 | 30 | 4.59484381 | 18.9 |
| 7B | 185 | 10 | 60 | 5.21114822 | 21.5 |
| 7B | 185 | 10 | 90 | 8.57148255 | 35.3 |
| 8B | 185 | 20 | 0 | 0.1635788 | 0.7 |
| 8B | 185 | 20 | 30 | 7.64178768 | 31.5 |
| 8B | 185 | 20 | 60 | 7.73596168 | 31.9 |
| 8B | 185 | 20 | 90 | 6.20023281 | 25.6 |
| 9B | 185 | 30 | 0 | 0.1635788 | 0.7 |
| 9B | 185 | 30 | 30 | 8.24039082 | 34.0 |
| 9B | 185 | 30 | 60 | 6.03295231 | 24.9 |
| 9B | 185 | 30 | 90 | 7.8020266 | 32.2 |
| 10B | 185 | 0 | 0 | 0.18104994 | 0.7 |
| 10B | 185 | 0 | 30 | 0.17234815 | 0.7 |
| 10B | 185 | 0 | 60 | 0.17749594 | 0.7 |
| 10B | 185 | 0 | 90 | 0.26512528 | 1.1 |
| 11B | 200 | 0 | 0 | 0.1635788 | 0.7 |
| 11B | 200 | 0 | 30 | 0.91109421 | 3.8 |
| 11B | 200 | 0 | 60 | 2.01653722 | 8.3 |
| 11B | 200 | 0 | 90 | 7.21665935 | 29.8 |
| 12A | 185 | 10 | 0 | 0.27463428 | 1.1 |
| 12A | 185 | 10 | 30 | 8.64916894 | 35.7 |
| 12A | 185 | 10 | 60 | 11.7489991 | 48.4 |

Table 8 illustrates the percent yield of glucose for samples 7B-12B after 0, 30, 60 and 90 minutes at the specified temperature.

TABLE 9

| | Temp | | Time | g Glucose | % Glucose |
|---|---|---|---|---|---|
| Sample Name | (° C.) | % Acid | (min.) | Produced | Yield |
| 13A | 185 | 10 | 0 | 0.16769727 | 0.7 |
| 13A | 185 | 10 | 30 | 1.91856191 | 7.9 |
| 13A | 185 | 10 | 60 | 3.80482415 | 15.7 |
| 14A | 185 | 10 | 0 | 0.17050245 | 0.7 |
| 14A | 185 | 10 | 30 | 1.65942026 | 6.8 |
| 14A | 185 | 10 | 60 | 1.66746942 | 6.9 |
| 15A | 185 | 10 | 0 | 0.1635788 | 0.7 |
| 15A | 185 | 10 | 30 | 0.87019407 | 3.6 |
| 15A | 185 | 10 | 60 | 1.63578803 | 6.7 |
| 16A | 185 | 30 | 0 | 0.1635788 | 0.7 |
| 16A | 185 | 30 | 30 | 8.70251321 | 35.9 |
| 16A | 185 | 30 | 60 | 7.35492624 | 30.3 |
| blank | | | | 0.1635788 | 0.7 |

Table 9 illustrates the percent yield of glucose for samples 13B-16B after 0, 30 and 60 minutes at the specified temperature.

TABLE 10

| | Summary Information | | | | |
|---|---|---|---|---|---|
| | | % | run A | Run B | Average |
| Sample | Temperature | acid | max yield | max yield | Glucose Yield |
| 1 | 150 | 10 | 1.2 | 1.7 | 1.4 |
| 2 | 150 | 20 | 14.0 | 19.2 | 16.6 |
| 3 | 150 | 30 | 19.4 | 11.2 | 15.3 |
| 4 | 175 | 10 | 18.4 | 33.1 | 25.8 |
| 5 | 175 | 20 | 40.5 | 52.3 | 46.4 |
| 6 | 175 | 30 | 36.9 | 37.5 | 37.2 |
| 7 | 185 | 10 | 34.8 | 35.3 | 35.1 |
| 8 | 185 | 20 | 30.1 | 31.9 | 31.0 |
| 9 | 185 | 30 | 29.2 | 34.0 | 31.6 |
| 10 | 185 | 0 | 0.8 | 1.1 | 1.0 |
| 11 | 200 | 0 | 20.6 | 29.8 | 25.2 |
| | runs stopped at 60 minutes | | | | |
| 12 | 185 | 10 | | 48.4 | 48.4 |
| 13 | 185 | 10 | | 15.7 | |
| 14 | 185 | 10 | | 6.9 | |
| 15 | 185 | 10 | | 6.7 | |
| 16 | 185 | 30 | | 35.9 | |

Table 10 is a summary of the data contained in tables 5-9 after 90 minutes at the specified temperature (unless specified).

TABLE 11

| | Solids | Hydrolyzing | | | |
|---|---|---|---|---|---|
| | description | Agent | Temp (° C.) | | |
| | Sample 17A | 10% acid | 185 | flake moisture 4.8% | flake wt 40.0 g |
| suspended solids | | | | | |
| filter weight dry % wt retained | 0.4118 1.4989 2.85 | 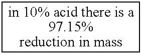 | | | 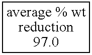 |
| water in soluble solids | | | | | |
| filter weight | 0.3763 | | | | |
| dry | 0.4283 | | | | |
| | 0.14% | | | | |
| | Sample 17B | 10% acid | 185 | flake moisture 4.8% | |
| suspended solids | | | | | |
| filter weight dry % wt retained | 0.4103 1.6191 3.17 | 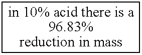 | | | |
| water in soluble solids | | | | | |
| filter weight | 0.409 | | | | |
| dry | 0.5864 | | | | |
| | 0.47% | | | | |
| | Sample 18B | 30% acid | 185 | filter rods | moisture 4.1% |
| suspended solids | | | | | |

| | | |
|---|---|---|
| filter weight dry % wt retained | 3.0963 4.5433 3.80 | 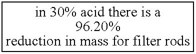 |
| water in soluble solids | | |
| filter weight | 3.0863 | |
| dry | 3.4608 | |
| | 0.98% | |

Table 11 illustrates the total reduction in the amount of solid waste remaining after the process described within the instant invention is complete.

1. A process for recycling cellulose acetate ester waste comprising the steps of:
providing a reactor;
adding a cellulose acetate ester waste to said reactor;
adding a hydrolyzing agent to said reactor to create an agent/waste mixture;
hydrolyzing said cellulose acetate ester waste by agitating and heating said agent/waste mixture for a period of time to create a hydrolyzed mixture;
distilling and/or separating out said hydrolyzing agent from said hydrolyzed mixture;
separating and removing solid material from said hydrolyzed mixture to create a water soluble product stream, said water soluble waste stream comprising monosaccharides, polysaccharides, partially hydrolyzed cellulose, acetic acid, or combinations thereof;
collecting said water soluble product stream.

2. The process of claim 1 wherein said cellulose acetate ester waste being a cellulose carboxylic ester.

3. The process of claim 2 wherein said cellulose carboxylic ester being a cellulose acetate (DS 0.5-3), cellulose diacetate, cellulose triacetate, cellulose acetate propionate (at various mixed ester composition), cellulose acetate butyrate (at various mixed ester composition), other cellulose acetate esters or combinations thereof.

4. The process of claim 1 wherein said hydrolyzing agent being a carboxylic acid selected from the group consisting of: acetic acid, formic acid, or combinations thereof.

5. The process of claim 4 wherein said hydrolyzing agent being generated or increased in-situ from hydrolyzation of said cellulose acetate waste as well as the consumption of water in the reaction.

6. The process of claim 1 further comprising the steps of: recovering said hydrolyzing agent by purification or isolation for subsequent use.

7. The process of claim 1 wherein said hydrolyzed mixture being primarily water soluble such that said solid material of the cellulose acetate waste is reduced by greater than 75%.

8. The process of claim 1 wherein said hydrolyzed mixture being primarily water soluble such that said solid material of the cellulose acetate waste is reduced by greater than 95% at 185° C.

9. The process of claim 1 further comprising the step of:
degrading a cellulose polymer resulting from the hydrolysis of said cellulose acetate ester waste proceeds to more than 30 percent of theoretical glucose yield.

10. The process of claim 1 wherein the hydrolysis of ester groups from said cellulose acetate ester waste proceeds to more than 70 percent of theoretical yield.

11. The process of claim 1 wherein said monosaccharides and/or polysaccharides being isolated to use as feedstock for subsequent processing.

12. The process of claim 1 further comprising the step of: processing said monosaccharides and/or polysaccharides to products such as acetic acid, ethanol, or combinations thereof.

13. The process of claim 1 further comprising the step of:
processing said monosaccharides and/or polysaccharides to products such as acetic acid, ethanol, or combinations thereof.

14. A process for recycling cellulose acetate waste comprising the steps of:
providing a reactor;
adding a cellulose acetate waste to said reactor;
adding a hydrolyzing agent to said reactor to create an agent/waste mixture;
hydrolyzing said cellulose acetate ester waste by agitating and heating said agent/waste mixture for a period of time to create a hydrolyzed mixture.

15. The process of claim 14 further comprising the step of distilling and/separating out said hydrolyzing agent from said hydrolyzed mixture.

16. The process of claim 15 further comprising the step of separating and removing solid material from said hydrolyzed mixture to create a water soluble product stream, said water soluble product stream comprising monosaccharides, polysaccharides, partially hydrolyzed cellulose, or combinations thereof.

17. The process of claim 16 further comprising the step of collecting said water soluble product stream.

18. The process of claim 14 wherein said hydrolyzed mixture being primarily water soluble such that said solid material of the cellulose acetate waste is reduced by greater than 75%.

19. The process of claim 14 further comprising the steps of: recovering said hydrolyzing agent by purification or isolation for subsequent use.

20. The process of claim 14 further comprising the step of: degrading a cellulose polymer resulting from the hydrolysis of said cellulose acetate ester waste proceeds to more than 30 percent of theoretical glucose yield.
